(19) United States
(12) Patent Application Publication
(10) Pub. No.: US 2014/0043502 A1
(43) Pub. Date: Feb. 13, 2014

(54) FLICKER NOISE DETECTION APPARATUS, FLICKER NOISE DETECTION METHOD, AND COMPUTER-READABLE STORAGE DEVICE STORING FLICKER NOISE DETECTION PROGRAM

(71) Applicant: OLYMPUS CORPORATION, Tokyo (JP)

(72) Inventor: Ken IOKA, Tokyo (JP)

(73) Assignee: OLYMPUS CORPORATION, Tokyo (JP)

(21) Appl. No.: 14/056,685

(22) Filed: Oct. 17, 2013

Related U.S. Application Data
(63) Continuation of application No. PCT/JP2012/002810, filed on Apr. 24, 2012.

(30) Foreign Application Priority Data
Apr. 28, 2011 (JP) 2011-102423

(51) Int. Cl. H04N 5/235

(52) U.S. Cl. CPC H04N 5/2357
USPC 348/226.1

(57) ABSTRACT

Provided is a flicker noise detection apparatus for detecting flicker noise in a video signal. The apparatus includes: a positional displacement detection module for detecting a positional displacement of an image across a plurality of sequential frames including, as a latest frame, a current frame of the video signal; a reference frame generation module for correcting, based on the positional displacement detected, the positional displacement of the image across the plurality of sequential frames, and generating a reference frame, based on the plurality of sequential frames corrected; and a flicker noise detection module for detecting, based on the reference frame generated and the current frame, flicker noise in the current frame.

The present application is a Continuing Application based on International Application PCT/JP2012/002810 filed on Apr. 24, 2012, which, in turn, claims the priority from Japanese Patent Application No.2011-102423 filed on Apr. 28, 2011, the entire disclosure of these earlier applications being herein incorporated by reference.

### TECHNICAL FIELD

The present invention relates to a flicker noise detection apparatus, a flicker noise detection method, and a computer-readable storage device, each for detecting flicker noise in a video signal.

### BACKGROUND ART

For example, when video imaging is performed by an imaging apparatus using an XY address type image sensor such as a complementary metal oxide semiconductor (CMOS) image sensor, under lighting of, for example, a fluorescent lamp whose brightness varies in accordance with the power frequency, there occur periodic light and dark changes, i.e., flicker noise in a pattern of horizontal lines in a vertical direction across successive frames or in one frame of a video signal.

The principle of the flicker noise generation is described in below. The AC power frequency in the world is basically either 50 Hz or 60 Hz. When a lighting system such as a fluorescent lamp is operated at the AC power frequency of 50 Hz, the lighting becomes brightest at a maximum amplitude of the power source current, and thus the intensity of light varies at 100 Hz that is twice as high as the power frequency. Accordingly, in the course of capturing a video image by an imaging device using a CMOS image sensor under fluorescent lighting whose brightness periodically varies as described above, photo charge accumulation occurs at different timings in respective frames and respective lines. As a result, the outputs from the frames and the lines of the image sensor fluctuate depending on the intensity of light incident thereon. Then, the fluctuations in the outputs emerge as fluctuations in luminance level on a display screen and are identified as flicker noise.

For example, when the imaging frame cycle is 1/30 seconds (30 Hz), the brightness of lighting is brought in phase in three-frame cycles, and thus the luminance levels of respective frames fluctuate for every three-frame cycle. In this specification, the fluctuation in luminance level is referred to as inter-frame flicker noise. Further, in the case of a CMOS image sensor, photo charge accumulation occurs at different timings for each line, which produces differences in luminance for each line in a frame, and such differences in luminance are identified as a pattern of repeating light and dark horizontal lines. In this specification, the fluctuations in luminance level in a pattern of horizontal lines are referred to as in-frame flicker noise. The inter-frame flicker noise and the in-frame flicker noise thus generated cause deterioration in quality of a captured image.

As described above, when a video image is captured by an imaging device using a CMOS image sensor under fluorescent lighting whose brightness periodically varies, photo charge accumulation occurs at slightly different timings in respective frames and respective lines, leading to fluctuations of the outputs from the frames and the lines of the image sensor depending on the intensity of light incident thereon, with the result that the fluctuations of the outputs emerge as fluctuations in luminance level on a display screen and are identified as flicker noise.

At the same time, when the power frequency is 60 Hz, the lighting becomes brightest at a maximum amplitude of the power source current, and thus the intensity of light varies at 120 Hz that is twice as high as the power frequency. In this case, supposing that the imaging frame cycle is, for example, 1/30 seconds (30 Hz), the frame cycle becomes equal to an integral multiple of the variation cycle of light intensity, and thus, the fluctuation in luminance level for each frame, which occurs when the power frequency is 50 Hz, does not occur in principle.

However, the fluctuations that occur at the power frequency of around 60 Hz produce light and dark (contrast) that appears to move for each frame, which leads to image quality deterioration. Further, when a CMOS image sensor is used, photo charge accumulation occurs at different timings for each line, and thus the resulting flicker noise emerges in one frame to be identified as a pattern of repeating light and dark horizontal lines on a display screen, leading to image quality deterioration.

As a method of correcting such flicker noise, there has been conventionally known a method of alleviating or eliminating flicker noise through image processing (see, for example, PTL 1).

### CITATION LIST

### Patent Literature

PTL 1: JP H10-93866 A

### SUMMARY OF INVENTION

According to a first aspect of the present invention, there is provided a flicker noise detection apparatus for detecting flicker noise in a video signal, which includes:

a positional displacement detection module for detecting a positional displacement of an image across a plurality of sequential frames including, as a latest frame, a current frame of the video signal;
a reference frame generation module for correcting, based on the positional displacement detected, the positional displacement of the image across the plurality of sequential frames, and generating a reference frame, based on the plurality of sequential frames corrected; and
a flicker noise detection module for detecting, based on the reference frame generated and the current frame, flicker noise in the current frame.

According to a second aspect of the present invention, the flicker noise detection apparatus according to the first aspect further includes a flicker noise detection control module for controlling, based on the detection result on the positional displacement obtained by the positional displacement detection module, an operation of detecting flicker noise in the current frame performed by the flicker noise detection module.

According to a third aspect of the present invention, in the flicker noise detection apparatus according to the second aspect,

the flicker noise detection module is for detecting the flicker noise and outputting a correction value thereof; and
the flicker noise detection control module is for controlling the correction value output from the flicker noise detection module.

According to a fourth aspect of the present invention, there is provided a flicker noise detection method including the steps of:

detecting a positional displacement of an image across a plurality of sequential frames including, as a latest frame, a current frame of the video signal;
correcting, based on the positional displacement detected, positional displacement of an image across the plurality of sequential frames, and generating a reference frame, based on the plurality of sequential frames corrected; and
detecting, based on the reference frame generated and the current frame, flicker noise in the current frame.

According to a fifth aspect of the present invention, there is provided a computer-readable storage device storing a flicker noise detection program for detecting flicker noise in a video signal, the flicker noise detection program causing a computer to execute:

a function of detecting a positional displacement of an image across a plurality of sequential frames including, as a latest frame, a current frame of the video signal;
a function of correcting, based on the positional displacement detected, the positional displacement of the image across the plurality of sequential frames, and generating a reference frame, based on the plurality of sequential frames corrected; and
a function of detecting, based on the reference frame generated and the current frame, flicker noise in the current frame.

### BRIEF DESCRIPTION OF DRAWINGS

The present invention will be further described below with reference to the accompanying drawings, wherein:

FIG. 1 is a functional block diagram illustrating a main part configuration of a flicker noise detection apparatus according to a first embodiment of the present invention;

FIG. 2 is a flowchart illustrating an operation of the flicker noise detection apparatus of FIG. 1;

FIG. 3 is a functional block diagram illustrating a main part configuration of a flicker noise detection apparatus according to a second embodiment of the present invention; and

FIG. 4 is a functional block diagram illustrating a main part configuration of a flicker noise detection/correction apparatus including a flicker noise detection apparatus according to a third embodiment of the present invention.

### DESCRIPTION OF EMBODIMENTS

In the following, embodiments of the present invention are described with reference to the accompanying drawings.

### First Embodiment

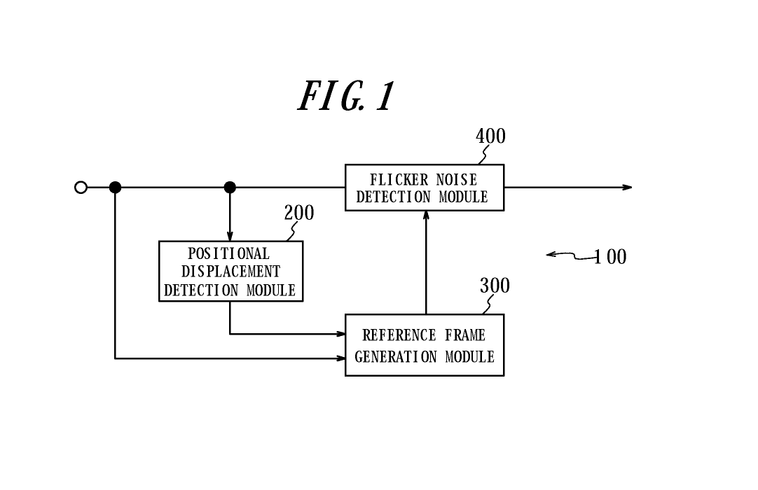

FIG. 1 is a functional block diagram illustrating a main part configuration of a flicker noise detection apparatus according to a first embodiment of the present invention. The flicker noise detection apparatus 100 includes processors such as a positional displacement detection module 200, a reference frame generation module 300, and a flicker noise detection module 400. The processors each may be configured by any form including: software to be executed on any suitable processor such as a central processing unit (CPU); a dedicated processor such as a digital signal processor (DSP) specialized in performing each process; and hard logic. Further, although not shown, the flicker noise detection apparatus 100 may further include a memory for storing a plurality of sequential frames of an input video signal, and various memories for temporarily storing intermediate processing results.

A video signal from, for example, a CMOS image sensor (not shown) is input in parallel to each of the positional displacement detection module 200, the reference frame generation module 300, and the flicker noise detection module 400. The positional displacement detection module 200 performs image processing using, for example, a known template matching method, to thereby detect positional displacement of an image between the current frame and the last frame. Here, the positional displacement detection module 200 may employ any image processing method other than the template matching method to detect a positional displacement. Alternatively, an external sensor such as a gyro sensor may be used for detecting a positional displacement, or an external sensor and image processing may be employed in combination to detect positional displacement, without being limited to the detection by software processing. The (amount of) positional displacement detected by the positional displacement detection module 200 is fed to the reference frame generation module 300.

Based on the positional displacement fed by the positional displacement detection module 200, the reference frame generation module 300 corrects an image in the current frame so as to coincide with the image in the last frame so that the images have no positional displacement from one another across the sequential frames, and generates a reference frame by averaging the images in a plurality of sequential frames, for example, three frames, including the current frame as the latest frame. The image in the reference frame generated by the reference frame generation module 300 is fed to the flicker noise detection module 400.

The flicker noise detection module 400 receives an input of the image of the current frame and the image of the reference frame fed from the reference frame generation module 300, and calculates, by a known method, flicker noise in the image of the current frame. The flicker noise calculated by the flicker noise detection module 400 is fed, for example, to a flicker noise corrector (not shown), for use in correcting the flicker noise of the current frame.

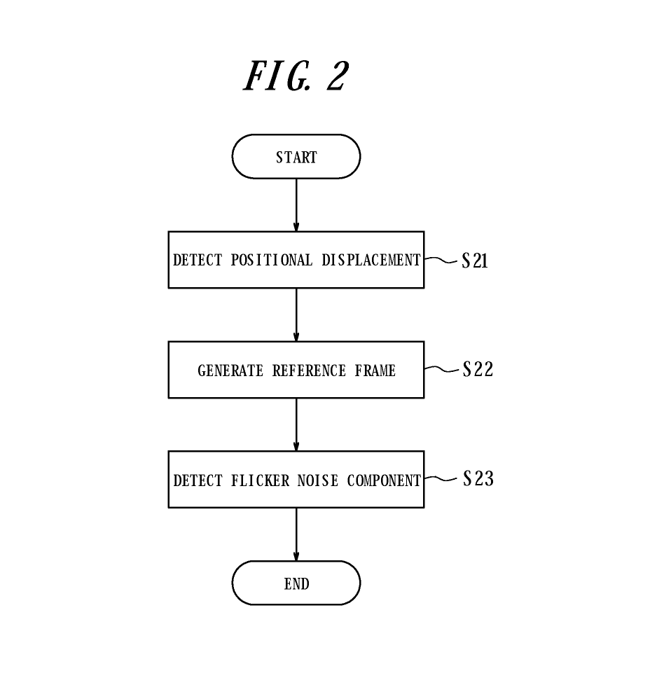

FIG. 2 is a flowchart illustrating an operation of the flicker noise detection apparatus of FIG. 1, which is briefly described in below as being redundant with the above description. First, the positional displacement detection module 200 detects a positional displacement of an image across a plurality of sequential frames of a video signal, the sequential frames including the current frame as the latest frame (Step S21). Next, based on the positional displacement detected by the positional displacement detection module 200, the reference frame generation module 300 corrects the positional displacement of the image across the plurality of frames, so as to generate a reference frame based on the plurality of corrected frames (Step S22). Thereafter, the flicker noise detection module 400 detects flicker noise in the current frame, based on the current frame and the reference frame generated by the reference frame generation module 300 (Step S23).

The functions of the flicker noise detection apparatus shown in FIG. 2 may be executed by a computer based on a flicker noise detection program stored in a computer-readable storage device. Here, examples of the program storage device for storing the aforementioned flicker noise detection program may include, for example, a CD-R, a CD-ROM, a DVD-ROM, a BD-ROM, a USB memory, a memory card, and a hard disk.

As described above, according to the flicker noise detection apparatus 100 of this embodiment, a positional displacement of an image between the current frame and the last frame is detected, and the positional displacement thus detected is first corrected before the images of the plurality of sequential frames are averaged to generate a reference frame. Therefore, an accurate reference frame can be generated even when pan/tilt shooting, camera shake, or object shake has caused significant positional displacement of the images across the successive frames of an input video signal. This configuration allows for accurate detection of flicker noise in the current frame based on the reference frame and the current frame.

### Second Embodiment

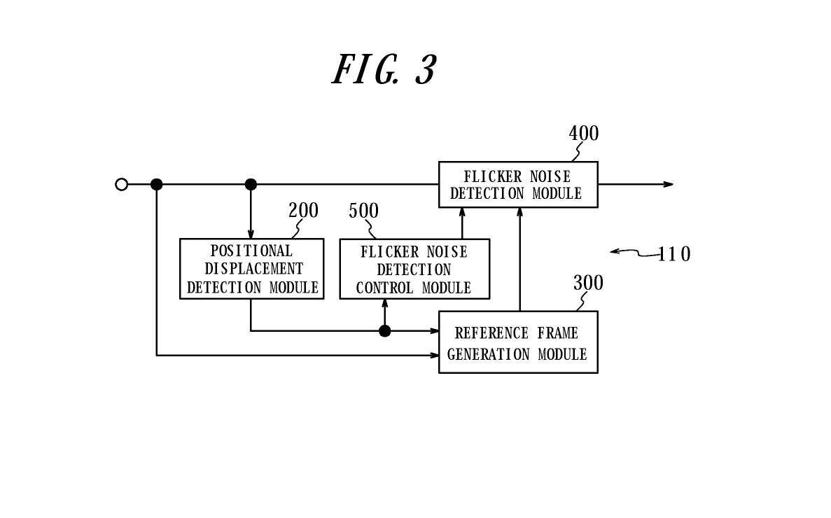

FIG. 3 is a functional block diagram illustrating a main part configuration of a flicker noise detection apparatus according to a second embodiment of the present invention. The flicker noise detection apparatus 110, which is similar to the flicker noise detection apparatus 100 of FIG. 1, additionally includes a flicker noise detection control module 500. Thus, constituent elements similar to those of FIG. 1 are denoted by the same reference numerals, and the description thereof is omitted.

The flicker noise detection control module 500 controls, based on the positional displacement detection result obtained by the positional displacement detection module 200, the operation of detecting flicker noise in the current frame by the flicker noise detection module 400. There may be a case where the positional displacement detection module 200 detects no positional displacement in the following cases, for example, where only part of the object has moved in successive frames, where the image has moved in a direction other than the horizontal and vertical directions, where the video scene has changed across a plurality of frames, where the image in the frames is low contrast, and where the image has many regularly arranged objects. In those cases, the reference frame generation module 300 generates a reference frame assuming that no positional displacement has occurred, and thus, the flicker noise detection process for the current frame, which is performed based on the reference frame generated by the reference frame generation module 300, may result in detection of a wrong flicker noise.

In view of the above, according to this embodiment, the flicker noise detection control module 500 controls the flicker noise detection module 400 not to detect flicker noise in the current frame when the positional displacement detection module 200 detects no positional displacement across the frames. As a result, false detection of flicker noise can be prevented.

### Third Embodiment

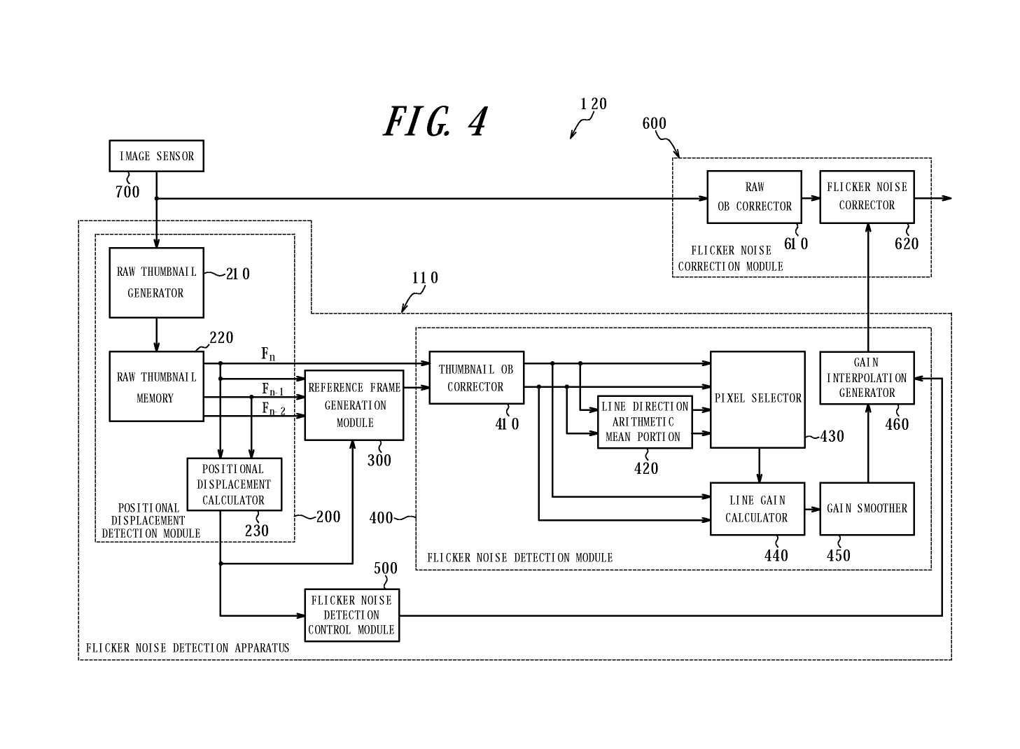

FIG. 4 is a functional block diagram illustrating a main part configuration of a flicker noise detection/correction apparatus including a flicker noise detection apparatus according to a third embodiment of the present invention. According to the flicker noise detection/correction apparatus 120, the flicker noise detection apparatus 110 of FIG. 3 additionally includes a flicker noise correction module 600 so that the flicker noise correction module 600 corrects an input video signal, based on flicker noise detected by the flicker noise detection apparatus 110. Here, a video signal is assumed to be input from an image sensor 700 including, for example, a CMOS image sensor, to the flicker noise detection/correction apparatus 120.

Referring to FIG. 4, the positional displacement detection module 200 includes: a RAW thumbnail generator 210; a RAW thumbnail memory 220; and a positional displacement calculator 230. The RAW thumbnail generator 210 generates RAW thumbnails based on RAW data on sequential frames from the image sensor 700. The RAW thumbnail memory 220 stores, for a plurality of frames, the RAW thumbnails of sequential frames, the RAW thumbnails being generated by the RAW thumbnail generator 210. Here, the RAW thumbnails are assumed to be stored for three frames including: a current frame Fₙ; a last frame Fₙ₋₁; and a second last frame Fₙ₋₂.

The RAW thumbnail of the current frame Fₙ stored in the RAW thumbnail memory 220 is fed to the positional displacement calculator 230, and also to the reference frame generation module 300 and the flicker noise detection module 400. Further, the RAW thumbnail of the last frame Fₙ₋₁ stored in the RAW thumbnail memory 220 is fed to the positional displacement calculator 230, and also to the reference frame generation module 300. The RAW thumbnail of the second last frame Fₙ₋₂ is fed to the reference frame generation module 300.

The positional displacement calculator 230 detects a positional displacement between the RAW thumbnail of the current frame Fₙ and the

RAW thumbnail of the last frame Fₙ₋₁ in a similar manner as described in the first embodiment, and feeds the detection results to the reference frame generation module 300 and to the flicker noise detection control module 500.

Based on the positional displacement fed by the positional displacement detection module 200, the reference frame generation module 300 corrects the positional displacement between the RAW thumbnail of the current frame Fₙ and the RAW thumbnail of the last frame Fₙ₋₁ in a similar manner as described in the first embodiment so that the RAW thumbnails of the sequential frames have no positional displacement. Then, based on the RAW thumbnails of the three sequential frames corrected for positional displacement, the reference frame generation module 300 generates a RAW thumbnail of a reference frame. The RAW thumbnail of the reference frame is fed to the flicker noise detection module 400.

The flicker noise detection module 400 has a thumbnail OB corrector 410, a line direction arithmetic mean portion 420, a pixel selector 430, a line gain calculator 440, a gain smoother 450, and a gain interpolation generator 460. The thumbnail OB corrector 410 corrects OB (Optical Black) of the RAW thumbnail of the current frame and the RAW thumbnail of the reference frame input thereto, that is, corrects a dark current of the image sensor 700.

The RAW thumbnails of the current frame and the reference frame which are OB-corrected by the thumbnail OB corrector 410 are fed to the line direction arithmetic mean portion 420, the pixel selector 430, and the line gain calculator 440. The line direction arithmetic mean portion 420 calculates an arithmetic mean of pixel values for each line of the respective RAW thumbnails of the current frame and the reference frame input thereto, and feds the calculation result to the pixel selector 430.

Based on the respective RAW thumbnails of the current frame and the reference frame fed by the thumbnail OB corrector 410, and on the arithmetic mean of the pixel values for each line of the respective RAW thumbnails of the current frame and the reference frame fed by the line direction arithmetic mean portion 420, the pixel selector 430 selects pixels that are under the influence of flicker noise. In other words, the pixel selector 430 excludes pixels for which no positional displacement is to be detected in sequential frames in the following cases, for example, where only part of the object has moved in successive frames, where the image has moved in a direction other than the horizontal and vertical directions, where the video scene has changed across a plurality of frames, where the image in the frames is low contrast, and where the image has many regularly arranged objects, so as to select pixels that are under the influence of flicker noise.

In the pixel selection process in the pixel selector 430, for example, the arithmetic mean value of pixel values of the current frame is multiplied with the reference frame for each line so as to calculate a maximum value and a minimum value of the line, and pixels each having a multiplication result of the arithmetic mean value of pixel values of the reference frame with the current frame that falls in between the maximum value and the minimum value are selected. Positional information on the pixels thus selected is fed to the line gain calculator 440.

The line gain calculator 440 extracts the pixel values of pixels selected by the pixel selector 430, from the respective RAW thumbnails of the current frame and the reference frame fed by the thumbnail OB corrector 410, so as to calculate, for each line, a gain for correcting flicker noise. In other words, the line gain calculator calculates, for each line, a gain that makes the pixel value of the current value be equal to the pixel value of the reference frame. The calculated gain for each line is fed to the gain smoother 450.

The gain smoother 450 subjects the gain for each line fed from the line gain calculator 440 to smoothing processing in a direction orthogonal to the line, and feeds the results to the gain interpolation generator 460. The gain interpolation generator 460 subjects the smoothed gain fed from the gain smoother 450 to interpolation processing in a direction orthogonal to the line, so as to generate a gain having the same number of lines as the original frame. Further, the gain interpolation generator 460 controls the interpolated gain, based on control signals from the flicker noise detection control module 500. The gain generated in the gain interpolation generator 460 is fed, as a correction value, to the flicker noise correction module 600.

Meanwhile, the flicker noise correction module 600 has a RAWOB corrector 610 and a flicker noise corrector 620. The RAWOB corrector 610 corrects OB of the RAW data on the current frame fed from the image sensor 700, and feeds the OB-corrected RAW data to the flicker noise corrector 620. Then, the flicker noise corrector 620 multiplies the OB-corrected RAW data on the current frame with the gain (correction value) fed from the gain interpolation generator 460 of the flicker noise detection module 400, to thereby output flicker noise-corrected RAW data.

In this embodiment, when the positional displacement detection module 200 detects no positional displacement between frames, the flicker noise detection control module 500 controls the gain interpolation generator 460 of the flicker noise detection module 400, so as to control the interpolated gain. For example, the interpolated gain is multiplied with a predetermined coefficient so that a smaller gain is to be fed to the flicker noise correction module 600. Alternatively, the interpolated gain is multiplied with a coefficient that is varied stepwisely so that the gain to be fed to the flicker noise correction module 600 becomes smaller in stages.

As described above, a smaller gain may be used for correcting flicker noise when the positional displacement detection module 200 detects no positional displacement between frames, in order to allow for efficient correction of flicker noise. Further, in the flicker noise detection module 400, pixels under the influence of flicker noise are selected and a gain of the line is calculated based on the pixel values of the selected pixels, and thus the detection accuracy of flicker noise can be increased, allowing for more effective correction of flicker noise.

The present invention is not limited to the above-mentioned embodiments, and may be subjected to various modifications and alterations without departing from the gist of the invention. For example, when the positional displacement detection module 200 detects no positional displacement in the second embodiment, the flicker noise detection control module 500 may also control, in addition to controlling the flicker noise detection module 400, the reference frame generation module 300 to stop the process of generating a reference frame.

### REFERENCE SIGN LIST

100, 110 flicker noise detection apparatus
120 flicker noise detection/correction apparatus
200 positional displacement detection module
300 reference frame generation module
400 flicker noise detection module
500 flicker noise detection control module
600 flicker noise correction module
700 image sensor

1. A flicker noise detection apparatus for detecting flicker noise in a video signal, comprising:
a positional displacement detection module for detecting a positional displacement of an image across a plurality of sequential frames including, as a latest frame, a current frame of the video signal;
a reference frame generation module for correcting, based on the positional displacement detected, the positional displacement of the image across the plurality of sequential frames, and generating a reference frame, based on the plurality of sequential frames corrected; and
a flicker noise detection module for detecting, based on the reference frame generated and the current frame, the flicker noise in the current frame.

2. The flicker noise detection apparatus according to claim 1, further comprising a flicker noise detection control module for controlling, based on the detection result on the positional displacement obtained by the positional displacement detection module, an operation of detecting the flicker noise in the current frame performed by the flicker noise detection module.

3. The flicker noise detection apparatus according to claim 2,
wherein the flicker noise detection module is for detecting the flicker noise and outputting a correction value thereof; and
wherein the flicker noise detection control module is for controlling the correction value output from the flicker noise detection module.

4. A flicker noise detection method for detecting flicker noise in a video signal, comprising the steps of:
detecting a positional displacement of an image across a plurality of sequential frames including, as a latest frame, a current frame of the video signal;
correcting, based on the positional displacement detected, the positional displacement of the image across the plurality of sequential frames, and generating a reference frame, based on the plurality of sequential frames corrected; and
detecting, based on the reference frame generated and the current frame, the flicker noise in the current frame.

5. A computer-readable storage device storing a flicker noise detection program for detecting flicker noise in a video signal, the flicker noise detection program causing a computer to execute:
a function of detecting a positional displacement of an image across a plurality of sequential frames including, as a latest frame, a current frame of the video signal;
a function of correcting, based on the positional displacement detected, the positional displacement of the image across the plurality of sequential frames, and generating a reference frame, based on the plurality of sequential frames corrected; and
a function of detecting, based on the reference frame generated and the current frame, the flicker noise in the current frame.
